(19) United States
(12) Patent Application Publication
(10) Pub. No.: US 2016/0134729 A1
(43) Pub. Date: May 12, 2016

(54) SHELL AND PREPARING METHOD AND USE OF THE SAME

(71) Applicant: BYD COMPANY LIMITED, Shenzhen, Guangdong (CN)

(72) Inventors: QING GONG, Shenzhen (CN); XINPING LIN, Shenzhen (CN); YONGZHAO LIN, Shenzhen (CN); FALIANG ZHANG, Shenzhen (CN); CHUANHUA WANG, Shenzhen (CN); BINGZHONG TANG, Shenzhen (CN); JIANXIN CHEN, Shenzhen (CN); XU ZHANG, Shenzhen (CN)

(21) Appl. No.: 14/896,689

(22) PCT Filed: Jun. 5, 2014
(86) PCT No.: PCT/CN2014/079304

§ 371 Date: Dec. 8, 2015

(30) Foreign Application Priority Data
Jun. 9, 2013 (CN) 201310231048.9

(51) Int. Cl. H04M 1/02; C22C 16/00; C22C 45/10

(52) U.S. Cl. CPC H04M 1/0202; C22C 45/10; C22C 16/00

(57) ABSTRACT

The present disclosure provides a shell, a method of preparing the same and the use of the shell. The shell includes: a base (1) made of ceramic; and a bending part (2) disposed connected with an edge of the base (1) and made of an amorphous alloy.

### CROSS-REFERENCE TO RELATED APPLICATION

This application claims priority to and benefits of Chinese Patent Application Serial No. 201310231048.9, filed with the State Intellectual Property Office of P. R. China on Jun. 9, 2013, the entire content of which is incorporated herein by reference.

### FIELD

The present disclosure generally relates to a shell, a method for preparing the same and use of the shell as a communication terminal shell.

### BACKGROUND

In recent years, a cell phone has become a necessary communication tool in our daily life. However, a shell of a cell phone is often worn easily with extended use, which may make the shell unappealing. Therefore, there are varieties of protective casings for cell phones. Often, these protective casings are mainly made of glass, a metal, or plastic, which may have a great visual effect and texture. However, those types of protective casings may have poor wear resistance and break resistance. Especially, most of the current cell phones are smart phones with a touch screen, which may have even poorer wear resistance and break resistance.

Therefore, there is a need to develop a new shell or casing which has excellent wear resistance and break resistance.

### SUMMARY

Embodiments of the present disclosure seek to at least partially solve one of the problems existing in the prior art.

Embodiments of the present disclosure provide a shell, which includes: a base made of ceramic; and a bending part connected with an edge of the base and made of an amorphous alloy.

Embodiments of the present disclosure also provide a method of preparing a shell. The method includes steps of providing a base made of ceramic, and forming a bending part made of an amorphous alloy on an edge of the base.

Embodiments of the present disclosure also provide the use of the shell mentioned above or the shell made by the method mentioned above as a communication terminal shell.

According to the present disclosure, the shell may have excellent wear resistance and break resistance, which is very suitable for a communication terminal.

In some embodiments, the bending part is formed by: providing a liquid alloy at a temperature of about 600 Celsius degrees to about 1000 Celsius degrees under a first pressure; maintaining the liquid alloy under a second pressure greater than the first pressure for about 1 minute to about 10 minutes, and cooling the liquid alloy at a cooling rate of about 100 Celsius degrees per second to about 200 Celsius degrees per second. Therefore, the shell may have better wear resistance and break resistance. This may be because: when the liquid alloy is provided under a relatively low pressure, there may be some tiny bubbles in the liquid alloy, and these tiny bubbles may be removed by increasing the pressure, and the base may be wetted by the liquid alloy more sufficiently, which is beneficial for the connection between the base and the bending part.

In some embodiments, the shell is manufactured in a mold, the mold defines a base chamber and a peripheral chamber which surrounds and communicates with a periphery of the base chamber and extends towards a bottom direction of the base chamber from the base chamber, forming the bending part includes: placing the base in the base chamber; heating the base to about 200 Celsius degrees to about 400 Celsius degrees; filling a liquid alloy at a temperature of about 600 Celsius degrees to about 1000 Celsius degrees into the peripheral chamber under a first pressure; maintaining the liquid alloy under a second pressure for about 1 minute to about 10 minutes, and cooling the liquid alloy at a cooling rate of about 100 Celsius degrees per second to about 200 Celsius degrees per second to form the bending part. The shell may have better wear resistance and break resistance.

It should be noted that although a ceramic may have high strength and hardness, and an amorphous alloy may have good tenacity and corrosion resistance, the compatibility between the base made of ceramic and the liquid alloy may be poor, and the base cannot be wetted by the liquid alloy sufficiently, such that the connection between the base and the bending part may be poor, which may reduce the break resistance of the shell. While when the base is preheated to about 200 Celsius degrees to about 400 Celsius degrees, and then the liquid alloy at a temperature of about 600 Celsius degrees to about 1000 Celsius degrees is filled into the mold, the compatibility between the base made of ceramic and the liquid alloy may be improved, the base may be wetted by the liquid alloy more sufficiently, which is helpful for improving the connection between the base and the bending part to obtain a shell with high break resistance.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings.

FIG. 1 is a schematic diagram of a shell according to an embodiment of the present disclosure; and

FIG. 2 is a cross-sectional view along line A-A in FIG. 1.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

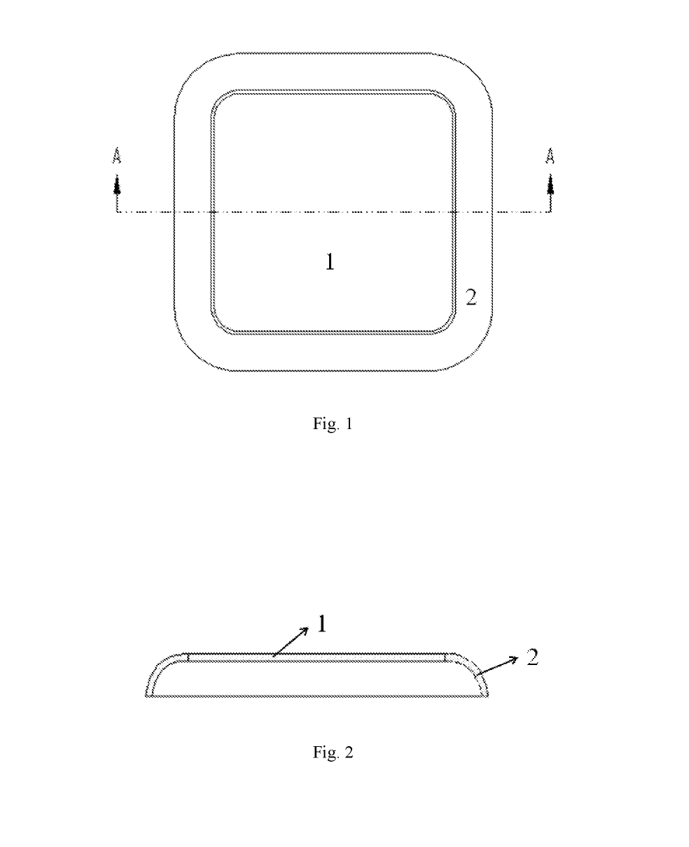

As shown in FIG. 1 and FIG. 2, embodiments of the present disclosure provide a shell. The shell includes a base 1 made of ceramic; and a bending part 2 connected with an edge of the base and made of an amorphous alloy.

It should be noted that the base 1 and the bending part 2 are integrally formed, and the bending part 2 may be designed according to actual needs. For example, the bending part 2 may be formed on four edges of the base 1; the bending part 2 may also be disposed on any three edges of the base 1; and the bending part 2 may also be disposed on two opposite edges of the base 1.

It should be noted that there are no particular limitations for a bending angle of the bending part 2, and it could be designed according to actual needs. For example, the bending part 2 may be perpendicular to the base 1 (that is, the bending angle is 90 degrees), or the bending part 2 may form a different angle in relation to the base 1.

In some embodiments, the bending part 2 and the base 1 are connected via a circular arc transition segment, and a radius of the circle arc transition segment is about 2.5 millimeters to about 5 millimeters. Therefore, a smooth transition between the bending part 2 and the base 1 may be realized, and the stress concentration may be reduced. It should be noted that the circle arc transition segment may be a part of the base 1, and the circular arc transition segment may also be a part of the bending part 2. That is, the material of the circular arc transition segment may be the same as the base 1, and the material of the circular arc transition segment may also be the same as the bending part 2.

In some embodiments, the base 1 has a hardness that is more than or equal to 1000 Hv, and the bending part 2 has a hardness that is more than or equal to less than 450 Hv. Therefore, the shell may have better wear resistance and break resistance. Thus an object to be protected, such as a communication terminal, may be placed into the shell easily.

It should be noted that the amorphous alloy may be any common amorphous alloy known to those skilled in the art. In one embodiment, the amorphous alloy includes a Zr-based amorphous alloy. Specifically, the Zr-based amorphous alloy may include Zr, Cu, Ni and Al. Based on the total weight of the Zr-based amorphous alloy, the content of Zr is about 60 wt % to 68 wt %, the content of Cu is about 23 wt % to 28 wt %, the content of Ni is about 5.5 wt % to 8 wt %, and the content of Al is about 3 wt % to 4 wt %.

The amorphous alloy may be commercially available, and the amorphous alloy may also be prepared according to various methods.

In some embodiments, the amorphous alloy is prepared by cooling an alloy with a melting point at a temperature of about 600 Celsius degrees to about 1000 Celsius degrees at a cooling rate of about 100 Celsius degrees per second to about 200 Celsius degrees per second. When the alloy is cooled at the cooling rate of about 100 Celsius degrees per second to about 200 Celsius degrees per second, there is not enough time for atoms of the alloy to orderly arrange themselves to form a crystal. As such, the cooled alloy obtained has a long-range disorder structure, which is commonly referred to as an “amorphous alloy”.

It should be noted that, if the thickness of the bending part 2 is greater than 1 millimeter, the bending part 2 made of the amorphous alloy may have a poor elastic buffering capacity and may be easily cracked. If the bending part 2 is thinner than 0.35 millimeters, then the alloy liquid may not fill into a mold completely during the molding, which may cause some structure defects. In some embodiments, the base 1 has a thickness of about 0.35 millimeters to about 1 millimeter, and the bending part 2 has a thickness of about 0.35 millimeters to about 1 millimeter. In some embodiments, the base 1 has a thickness of about 0.5 millimeters to about 0.8 millimeter, and the bending part 2 has a thickness of about 0.5 millimeters to about 0.8 millimeter.

It should be noted that some holes, through which a button or a socket may be exposed, may also be formed in the base 1 or the bending part 2 of the shell. For example, when the shell according to the present disclosure is used as a cell phone shell, one or more of a volume button hole, a power button hole, a headphone jack hole, a charging port hole and a SIM slot hole may be formed in the bending part 2 of the shell.

Embodiments of the present disclosure also provide a method of preparing a shell. The method includes steps of providing a base made of ceramic, and forming a bending part made of an amorphous alloy on an edge of the base.

There are no particular limitations to a process for forming the bending part on the edge of the base. In some embodiments, forming the bending part on the edge of the base includes: providing an alloy with a melting point at a temperature of about 600 Celsius degrees to about 1000 Celsius degrees under a first pressure; maintaining the liquid alloy under a second pressure greater than the first pressure for about 1 minute to about 10 minutes; and cooling the liquid alloy at a cooling rate of about 100 Celsius degrees per second to about 200 Celsius degrees per second. Therefore, bubbles in the alloy may be avoided effectively. The base 1 may be in contact with the liquid alloy sufficiently to improve the connection between the base and the bending part.

Specifically, in some embodiments, the shell is prepared in a enclosed mold. The enclosed mold defines a base chamber, and a peripheral chamber which surrounds and connects with a periphery of the base chamber and extends towards a bottom direction of the base chamber from the base chamber. It should be noted that the enclosed mold could be disassembled, and therefore objects to be molded, such as the base 1, may be placed in the enclosed mold first, then the enclosed mold may be assembled.

It should be noted that there are no particular limitations for a bending angle of the peripheral chamber, and it could be designed according to actual needs. For example, the peripheral chamber may be perpendicular to the base chamber (that is, the bending angle is 90 degrees), or the peripheral chamber may form a different angle in relation to the base chamber.

When the shell is manufactured in the enclosed mold, the base is firstly placed in the base chamber, and then the liquid alloy is filled into the peripheral chamber. The method for filling the liquid alloy into the peripheral chamber may be any common methods known to those skilled in the art. For example, in one embodiment, the liquid alloy is first filled into a storage container connected to the peripheral chamber via a pipeline, and then at least a part of the liquid alloy is forced into the peripheral chamber by applying a pressure to the liquid alloy in the storage container so as to full fill the peripheral chamber. It should be noted that, in this embodiment, the first pressure and the second pressure both mean the pressure applied to the liquid alloy in the storage container.

In some embodiments, when manufacturing the shell in the enclosed mold, forming the bending part on the edge of the base includes: placing the base 1 in the base chamber; preheating the base 1 to about 200 Celsius degrees to about 400 Celsius degrees; filling a liquid alloy at a temperature of about 600 Celsius degrees to about 1000 Celsius degrees into the peripheral chamber under a first pressure; maintaining the liquid alloy under a second pressure for about 1 minute to about 10 minutes, and cooling the liquid alloy at a cooling rate of about 100 Celsius degrees per second to about 200 Celsius degrees per second to form the bending part 2. Therefore, the shell may have better wear resistance and break resistance.

It should be noted that there are no particular limitations to the values of the first pressure and the second pressure. It is only required that the first pressure be sufficient to force the liquid alloy into the peripheral chamber and the second pressure be sufficient to remove tiny bubbles in the liquid alloy. In some embodiments, the second pressure is greater than the first pressure by about 0.01 MPa to about 0.07 Mpa. In some embodiments, the first pressure is about 0.01 Mpa to about 0.05 MPa, and the second pressure is about 0.05 MPa to about 0.08 MPa. It should be noted that the first pressure and the second pressure mean a gage pressure.

It should be noted that there are no particular limitations for the amorphous alloy. For example, the amorphous alloy includes a Zr-based amorphous alloy.

In embodiments of the present disclosure, the enclosed mold provided with the base and filled with the liquid alloy may be placed in a cooling medium to realize quick cooling. The cooling medium may be any commonly used cooling medium in the art. The cooling rate may be controlled by the type and amount of the cooling medium, which is well known to those skilled in the art, and therefore the detailed description thereof is omitted.

In addition, according to actual needs, the method according to the present disclosure may further include a step of forming one or more holes in the base 1 or the bending part 2, such that a button or a slot may be exposed through the hole.

Embodiments of the present disclosure also provide the use of the shell described above or the shell made by the method mentioned above as a communication terminal shell.

The present disclosure will be described in detail with reference to the following examples.

In examples and similar examples described below, the liquid alloy is a Zr-based amorphous liquid alloy, which includes Zr, Cu, Ni, and Al. Based on the total weight of the Zr-based amorphous liquid alloy, the content of Zr is about 65 wt %, the content of Cu is about 25 wt %, the content of Ni is about 6 wt %, and the content of Al is about 4 wt %.

### Embodiment 1

This example is used herein for illustrating the shell and the method of preparing the shell according to embodiments of the present disclosure.

In this embodiment, the closed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 0.35 mm and a height of 5 mm.

First, a ceramic bottom board having a planar structure is prepared. The ceramic bottom board has a size of 45 mm×45 mm×1.5 mm, and a radian of four corners of the ceramic bottom board is R3.5 mm.

Then, the ceramic bottom board is placed in the base chamber, and preheated to 400 Celsius degrees. A liquid alloy at a temperature of 950 Celsius degrees is filled in a storage container connected with the peripheral chamber via a pipeline, and at least a part of the liquid alloy is forced into the peripheral chamber by applying a pressure of 0.05 Mpa to the liquid alloy so as to full fill the peripheral chamber. Then, the pressure is increased to 0.09 Mpa and maintained for 2 minutes. Then, the closed mold is placed in a cooling medium to cool the liquid alloy quickly. The cooling rate is controlled at 200 Celsius degrees per second. Then, a shell sample K1 including a base 1 and a bending part 2 is obtained. The base 1 has a hardness of 1000 Hv, and the bending part 2 has a hardness of 500 Hv.

To test the wear resistance of the shell, a brick having a weight of 1 kg is then placed on the shell sample K1, and then the shell sample K1 is pushed to move for 100 meters on a cement floor at a speed of 10 meters per minute, with the ceramic bottom in contact with the floor. In this embodiments, there are no scratches on the surface of the shell sample K1 caused by moving the shell on the floor. In addition, the shell sample K1 may be dropped from a height of 5 meters and 10 meters to a cement floor respectively (with initial velocities of 0 in both cases). No cracks on the surface of the shell sample K1 would be caused by the drop. The results show that the shell sample K1 is wear resistant and break resistant.

### Embodiment 2

This example is used herein for illustrating the shell and the method of preparing the shell according to embodiments of the present disclosure.

In this example, the closed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 1 mm and a height of 5 mm.

First, a ceramic bottom board having a planar structure is prepared. The ceramic bottom board has a size of 45 mm×45 mm×1.5 mm, and a radian of four corners of the ceramic bottom board is R3.5 mm.

Then, the ceramic bottom board is placed in the base chamber, and preheated to 200 Celsius degrees. A liquid alloy at a temperature of 600 Celsius degrees is filled in a storage container connected with the peripheral chamber via a pipeline, and at least a part of the liquid alloy is forced into the peripheral chamber by applying a pressure of 0.01 Mpa to the liquid alloy so as to full fill the peripheral chamber. Then, the pressure is increased to 0.06 Mpa and maintained for 10 minutes. Then, the closed mold is placed in a cooling medium to cool the liquid alloy quickly. The cooling rate is controlled at 100 Celsius degrees per second. Thus, a shell sample K2 including a base 1 and a bending part 2 is obtained. The base 1 has a hardness of 1000 Hv, and the bending part 2 has a hardness of 500 Hv.

To test the wear resistance of the shell, a brick having a weight of 1 kg is then placed on the shell sample K2, and then the shell sample K2 is pushed to move for 100 meters on a cement floor at a speed of 10 meters per minute, with the ceramic bottom in contact with the floor. There are no scratches on the surface of the shell sample K2. To test the break resistance of the shell, the shell sample K2 is then dropped from a height of 5 meters and 10 meters to a cement floor respectively (initial velocities both are 0). There are no cracks on the surface of the shell sample K2. The results show that the shell sample K2 is wear resistant and break resistant.

### Embodiment 3

This example is used herein for illustrating the shell and the method of preparing the shell according to embodiments of the present disclosure.

In this embodiment, the enclosed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 0.6 mm and a height of 5 mm.

First, a ceramic bottom board having a planar structure is prepared. The ceramic bottom board has a size of 45 mm×45 mm×1.5 mm, and a radian of four corners of the ceramic bottom board is R3.5 mm.

Then, the ceramic bottom board is placed in the base chamber, and preheated to 300 Celsius degrees. A liquid alloy at a temperature of 800 Celsius degrees is filled in a storage container connected with the peripheral chamber via a pipeline, and at least a part of the liquid alloy is forced into the peripheral chamber by applying a pressure of 0.03 Mpa to the liquid alloy so as to full fill the peripheral chamber. Then, the pressure is increased to 0.07 Mpa and maintained for 6 minutes. Then, the closed mold is placed in a cooling medium to cool the liquid alloy quickly. The cooling rate is controlled at 150 Celsius degrees per second. Then, a shell sample K3 including a base 1 and a bending part 2 is obtained. The base 1 has a hardness of 1000 Hv, and the bending part 2 has a hardness of 500 Hv.

To test the wear resistance, a brick having a weight of 1 kg is placed on the shell sample K3, and then the shell sample K3 is pushed to move for 100 meters on a cement floor at a speed of 10 meters per minute, with the ceramic bottom in contact with the floor. There are no scratches on the surface of the shell sample K3. To test the break resistance, the shell sample K3 is dropped from a height of 5 meters and 10 meters to a cement floor respectively (initial velocities both are 0). There are no cracks on the surface of the shell sample K3. The results show that the shell sample K3 is wear resistant and break resistant.

### Embodiment 4

This example is used herein for illustrating the shell and the method of preparing the shell according to embodiments of the present disclosure.

In this example, the closed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 0.35 mm and a height of 5 mm.

First, a ceramic bottom board having a planar structure is prepared. The ceramic bottom board has a size of 45 mm×45 mm×1.5 mm, and a radian of four corners of the ceramic bottom board is R3.5 mm.

Then, the ceramic bottom board is placed in the base chamber, and preheated to 400 Celsius degrees. A liquid alloy at a temperature of 950 Celsius degrees is filled in a storage container connected with the peripheral chamber via a pipeline, and at least a part of the liquid alloy is forced into the peripheral chamber by applying a pressure of 0.05 Mpa to the liquid alloy so as to full fill the peripheral chamber. The pressure is maintained for 2 minutes. Then, the closed mold is placed in a cooling medium to cool the liquid alloy quickly. The cooling rate is controlled at 200 Celsius degrees per second. Then, a shell sample K4 including a base 1 and a bending part 2 is obtained. The base 1 has a hardness of 1000 Hv, and the bending part 2 has a hardness of 500 Hv.

To test wear resistance, a brick having a weight of 1 kg is placed on the shell sample K4, and then the shell sample K4 is pushed to move for 100 meters on a cement floor at a speed of 10 meters per minute, with the ceramic bottom in contact with the floor. There are no scratches on the surface of the shell sample K4. To test break resistance, the shell sample K4 is dropped from a height of 5 meters and 10 meters to a cement floor respectively (initial velocities both are 0). There are no cracks on the surface of the shell sample K4 when the shell sample K4 falls from a height of 5 meters. When the shell sample K4 falls from a height of 10 meters, a small crack appears on the bending part of the shell sample K4.

### Embodiment 5

This example is used herein for illustrating the shell and the method of preparing the shell according to embodiments of the present disclosure.

In this embodiment, the closed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 0.35 mm and a height of 5 mm.

First, a ceramic bottom board having a planar structure is prepared. The ceramic bottom board has a size of 45 mm×45 mm×1.5 mm, and a radian of four corners of the ceramic bottom board is R3.5 mm.

Then, the ceramic bottom board is placed in the base chamber. A liquid alloy at a temperature of 950 Celsius degrees is filled in a storage container connected with the peripheral chamber via a pipeline, and at least a part of the liquid alloy is forced into the peripheral chamber by applying a pressure of 0.05 Mpa to the liquid alloy so as to full fill the peripheral chamber. Then, the pressure is increased to 0.09 Mpa and maintained for 2 minutes. Then, the closed mold is placed in a cooling medium to cool the liquid alloy quickly. The cooling rate is controlled at 200 Celsius degrees per second. Thus, a shell sample K5 including a base 1 and a bending part 2 is obtained. The base 1 has a hardness of 1000 Hv, and the bending part 2 has a hardness of 500 Hv.

To test wear resistance, a brick having a weight of 1 kg is placed on the shell sample K5, and then the shell sample K5 is pushed to move for 100 meters on a cement floor at a speed of 10 meters per minute, with the ceramic bottom in contact with the floor. There are no scratches on the surface of the shell sample K5. To test break resistance, the shell sample K5 is dropped from a height of 5 meters and 10 meters to a cement floor respectively (initial velocity both are 0). It is found that there are no cracks on the surface of the shell sample K5 when the shell sample K5 falls from a height of 5 meters. When the shell sample K5 falls from a height of 10 meters, the base 1 and the bending part 2 are separated from each other.

### Comparative Example 1

This example is used herein for illustrating a comparative shell and a method of preparing the comparative shell.

In this example, the closed mold includes a base chamber, and a peripheral chamber which surrounds and connects with a periphery of the base chamber and extends towards a bottom direction of the base chamber from the base chamber. The size of the base chamber is 45 mm×45 mm×1.5 mm, and a radian of four corners of the base chamber is R3.5 mm. The base chamber and the peripheral chamber are connected via a circular arc transition segment which has a radian of R3.5 mm, and the peripheral chamber has a thickness of 0.35 mm and a height of 5 mm.

A liquid alloy at a temperature of 950 Celsius degrees is filled in a storage container connected with the peripheral chamber via a pipeline, and at least a part of the liquid alloy is forced into the peripheral chamber by applying a pressure of 0.05 Mpa to the liquid alloy so as to full fill the peripheral chamber. The pressure is maintained for 2 minutes. Then, the closed mold is placed in a cooling medium to cool the liquid alloy quickly. The cooling rate is controlled at 200 Celsius degrees per second. Then, a comparative shell sample DK1 including a base 1 and a bending part 2 is obtained. The base 1 has a hardness of 500 Hv, and the bending part 2 has a hardness of 500 Hv.

To test wear resistance, a brick having a weight of 1 kg is placed on the shell sample DK1, and then the comparative shell sample DK1 is pushed to move for 100 meters on a cement floor at a speed of 10 meters per minute, with the ceramic bottom in contact with the floor. There are many scratches on the surface of the comparative shell sample DK1. To test break resistance, the comparative shell sample DK1 is dropped from a height of 5 meters and 10 meters to a cement floor respectively (initial velocity both are 0). There are two cracks on the surface of the comparative shell sample DK1 even when the comparative shell sample DK1 falls from a height of 5 meters.

As can be seen from the embodiments consistent with the present disclosure and the Comparative Example, the shell according to the present disclosure has excellent wear resistance and break resistance.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A shell, comprising:
a base made of ceramic; and
a bending part connected with an edge of the base and made of an amorphous alloy.

2. The shell of claim 1, wherein the base has a thickness of about 0.35 millimeters to about 1 millimeter, and the bending part has a thickness of about 0.35 millimeters to about 1 millimeter.

3. The shell of claim 1, wherein the base has a hardness of no less than 1000 Hv, and the bending part has a hardness of no less than 450 Hv.

4. The shell of any one of claim 1, wherein the amorphous alloy comprises a Zr-based amorphous alloy.

5. The shell of any one of claim 1, wherein the bending part and the base are connected via a circular arc transition segment, and a radius of the circular arc transition segment is about 2.5 millimeters to about 5 millimeters.

6. The shell of any one of claim 1, wherein the amorphous alloy is prepared by cooling a liquid alloy at a temperature of about 600 Celsius degrees to about 1000 Celsius degrees at a cooling rate of about 100 Celsius degrees per second to about 200 Celsius degrees per second.

7. A method of preparing a shell, comprising steps of:
providing a base made of ceramic, and
forming a bending part made of an amorphous alloy on an edge of the base.

8. The method of claim 7, wherein forming the bending part comprises:
providing a liquid alloy at a temperature of about 600 Celsius degrees to about 1000 Celsius degrees under a first pressure;
maintaining the liquid alloy under a second pressure greater than the first pressure for about 1 minute to about 10 minutes; and
cooling the liquid alloy at a cooling rate of about 100 Celsius degrees per second to about 200 Celsius degrees per second.

9. The method of claim 7, wherein the shell is prepared in a mold defining a base chamber and a peripheral chamber which surrounds and connects with a periphery of the base chamber and extends towards a bottom direction of the base chamber from the base chamber, wherein forming a bending part comprises:
placing the base in the base chamber;
preheating the base to about 200 Celsius degrees to about 400 Celsius degrees;
filling a liquid alloy at a temperature of about 600 Celsius degrees to about 1000 Celsius degrees into the peripheral chamber under a first pressure;
maintaining the liquid alloy under a second pressure for about 1 minute to about 10 minutes, and
cooling the liquid alloy at a cooling rate of about 100 Celsius degrees per second to about 200 Celsius degrees per second to form the bending part.

10. The method of claim 9, wherein filling the liquid alloy comprises:
supplying the liquid alloy into a storage container connected with the peripheral chamber via a pipeline, and
applying a pressure to the liquid alloy in the storage container to force at least a part of the liquid alloy into the peripheral chamber so as to full fill the peripheral chamber.

11. The method of any one of claim 8, wherein the second pressure is greater than the first pressure by about 0.01 MPa to about 0.07 Mpa.

12. The method of any one of claim 8, wherein the first pressure is about 0.01 Mpa to about 0.05 MPa, and the second pressure is about 0.05 MPa to about 0.08 MPa.

13. The method of any one of claim 8, wherein the liquid alloy comprises a Zr-based amorphous liquid alloy.

14. (canceled)

15. The shell of claim 1, wherein the liquid alloy is first placed under a first pressure and then placed under a second pressure greater than the first pressure for a pre-set period.
